(19) United States
(12) Patent Application Publication
(10) Pub. No.: US 2009/0009311 A1
(43) Pub. Date: Jan. 8, 2009

(54) Method of Detecting a Transmission Fault in Relation to a Wheel Unit Belonging to a Tire Pressure Monitoring System and Corresponding Device

(75) Inventor: Valerie Escarpit, Fontenilles (FR)

Correspondence Address: YOUNG & THOMPSON, 209 Madison Street, Suite 500, ALEXANDRIA, VA, 22314, US

(73) Assignee: SIEMENS VDO AUTOMOTIVE, Toulouse Cedex 1 (FR)

(21) Appl. No.: 11/885,436

(22) PCT Filed: Mar. 10, 2006
(86) PCT No.: PCT/EP06/02222

§ 371 Date: Aug. 31, 2007

(30) Foreign Application Priority Data
Mar. 23, 2005 (FR) 0502858

(51) Int. Cl. B60C 23/02

(52) U.S. Cl. 340/447

(57) ABSTRACT

A method of detecting a transmission fault of a wheel unit belonging to a tire pressure monitoring system which includes a plurality of wheel units associated with a central unit placed in the vehicle. The method includes:
a) transmitting messages by the wheel units,
b) receiving these messages by the central unit having an active antenna exhibiting a plurality of reception lobes each able to receive a message originating from a predetermined wheel unit,
c) when a lobe has received a message originating from the wheel unit with which it is associated, deactivating this lobe,
d) repeating steps b) and c) until all the lobes have received a message,
e) if after a predetermined time span all the messages of all the wheel units have been received, all the lobes are reactivated, in the converse case the wheel units whose messages have not been received are counted “mute”.

The present invention relates to a method of detecting a transmission fault of a wheel unit belonging to a tire pressure monitoring system. The invention also extends to a corresponding device. More particularly, such a tire pressure monitoring system is called upon to be implemented in a motor vehicle.

It is already known to provide a motor vehicle with a system for monitoring the pressure of the tires. Such a system makes it possible in particular to inform the driver of any anomaly. The information is given to the driver by display on a screen, by voice synthesis, by an audible and/or luminous blip etc. or any appropriate means.

For this purpose a tire pressure monitoring system conventionally consists of:

a plurality of wheel units. Each wheel unit is placed inside a tire of the vehicle. This wheel unit comprises at least one temperature and pressure sensor, (it can also comprise an acceleration sensor or any other appropriate sensor), a microchip able to process the signals received from these sensors and to shape them for transmission of a message by a radio frequency transmitter.

and a central unit placed in the motor vehicle and comprising a single radio frequency receiver receiving the transmissions originating from each wheel. This central unit is able to process the messages transmitted by the wheel units and to inform the driver of any anomaly as necessary.

In a customary manner the message transmitted by the wheel units contains at least the measured pressure and temperature values (possibly other parameters), a code identifying the transmitting wheel unit, as well as a certain number of data making it possible to verify the consistency of the message.

Each wheel unit dispatches its message according to a predetermined tempo when the vehicle is moving, and at a tempo (generally lesser) when the vehicle is stationary. However the dispatching of the messages between various wheel units is not coordinated. Thus it is possible for one or more wheel units to dispatch their messages at the same time. As the vehicle is equipped with only a single receiving antenna, there are then message collisions and non-receipt of the content of this message, at the central unit level. Now, when the central unit does not receive any message originating from a determined wheel for a certain time span, it declares that this wheel is “mute”.

By declaring a wheel unit “mute” although this is not the case, a non-existent fault is created, while the real fault which turns out to be a message collision problem is not detected.

Furthermore, it is commonplace for the collision between the transmission of two messages to occur over a relatively long period, either because the transmissions of two wheel units are unfortunately synchronized, or because the ambient medium is disturbed, in an enduring manner, by a powerful electromagnetic field (example: car near an antenna, a significant metallic structure, high-voltage line, etc.) preventing the central unit from receiving the messages correctly.

Therefore it is impossible to know exactly whether a wheel unit is “mute” (that is to say if it is exhibiting a genuine transmission problem) or whether it is encountering message collision problems (but is otherwise operating appropriately).

In particular, document EP 1 059 177 already discloses a method of detecting transmission of a wheel unit belonging to a system for monitoring tires using a central antenna having a lobe distribution that can be switched via a phase-shifting electronic device. Nevertheless, such a method necessitates switching between each of the lobes, and therefore certain messages may not be received if the central antenna is not switched over to the correct lobe when the message is dispatched.

Moreover, document WO 94/06640 discloses a method of detecting transmission of a wheel unit in which a central antenna comprises several lobes, each suitable for receiving the messages originating from a specific wheel. However, such a method does not describe or suggest means for avoiding collisions between messages and hence does not prevent a wheel from being declared mute in error. The aim of the present invention therefore is to detect, in a reliable manner, whether a wheel unit is mute (that is to say whether it is not transmitting).

For this purpose the present invention proposes a method of detecting a transmission fault of a wheel unit belonging to a tire pressure monitoring system. Such a system customarily comprises:

a plurality of wheel units, comprising at least means for measuring the pressure prevailing inside the tire, means for processing the measurements performed and means for shaping and for dispatching a message containing at least the measurements performed and an identifier of the wheel unit, to a central unit,

and a central unit placed in the vehicle, able to process the messages received from each wheel unit.

According to the invention the method is characterized in that it comprises the following steps:

a) transmissions of messages by the wheel units,

b) reception of these messages by the central unit provided with an active antenna exhibiting a plurality of reception lobes each able to receive a message originating from a predetermined wheel unit,

c) when a lobe has received a message originating from the wheel unit with which it is associated, deactivation of this lobe and standby for the next messages transmitted for the lobes that remain active,

d) repetition of steps b) and c) until all the lobes of the active antenna have received a message,

e) if after a predetermined time span all the messages of all the wheel units have been received, all the reception lobes are reactivated, in the converse case the wheel units whose messages have not been received are counted “mute”, then the reception lobes are all reactivated.

Thus the invention consists in reducing the number of active reception lobes of a receiving antenna (comprising a plurality of lobes) situated in the vehicle, as the messages are received. By decreasing the number of lobes that are capable of receiving a message from a wheel unit, the risks of collisions between the messages transmitted by the wheel units are also decreased. Specifically, the number of messages that can be received by the central unit is decreased and therefore the risks of collision between these messages are decreased.

It should be noted that deactivating a reception lobe of the active antenna prevents the central unit from receiving the messages originating from the wheel unit associated with this lobe. However this deactivation is temporary, since it lasts only the time to receive the messages for the other active reception lobes. The deactivation is therefore of very short duration and does not degrade the operating performance of the tire pressure monitoring system.

The invention thus uses the principle that a message received by a reception lobe of the central unit does not need to be received again at the risk of recolliding with the subsequent messages originating from other wheel units.

Of course, if during a determined time span the central unit does not receive any message originating from a wheel unit, this wheel unit is counted “mute”, and the lobes of the active antenna are reactivated. It is of course out of the question for the active antenna to remain indefinitely on standby for a message and therefore no longer ensure regular reception of the messages originating from the wheel units.

It will be noted that the wheel unit from which no message has been received is first of all counted as “mute”. When this wheel unit is counted “mute” a certain number of times, it is thereafter declared “mute”. This two-stage procedure makes it possible not to declare “mute” a wheel unit which has only a momentary transmission problem or message collision problem. Therefore, only a wheel unit from which the central unit has not received any message for a certain time will be declared “mute”, even though the collision reduction method according to the invention is implemented. In that case, it is indeed possible to be practically certain that the non-receipt of messages is due to non-transmission and not to a collision problem.

The invention also extends to a device implementing the detection method according to the invention. More particularly, this device comprises a multilobed active antenna with controlled reception lobes.

The active antenna is furthermore always positioned in the vehicle in an identical manner so that a defined lobe always covers a determined zone of the vehicle.

For this purpose, the active antenna is provided with foolproofing means, enabling it to be installed in the vehicle according to a predetermined position, whatever the vehicle.

Advantageously, the detection method according to the invention also makes it possible to locate the wheel units on the vehicle. Specifically as each lobe of the active antenna covers a given wheel in a specific manner (front left, front right, rear left, rear right, etc.), when a lobe receives the message from the wheel unit with which it is associated, it suffices to store the number identifying this wheel unit (present in the message transmitted) and to associate it with the zone covered by the lobe, so as to locate each wheel unit on the vehicle.

Other objects, characteristics and advantages of the present invention will additionally emerge from the description which follows, by way of nonlimiting example, with reference to the appended drawings in which:

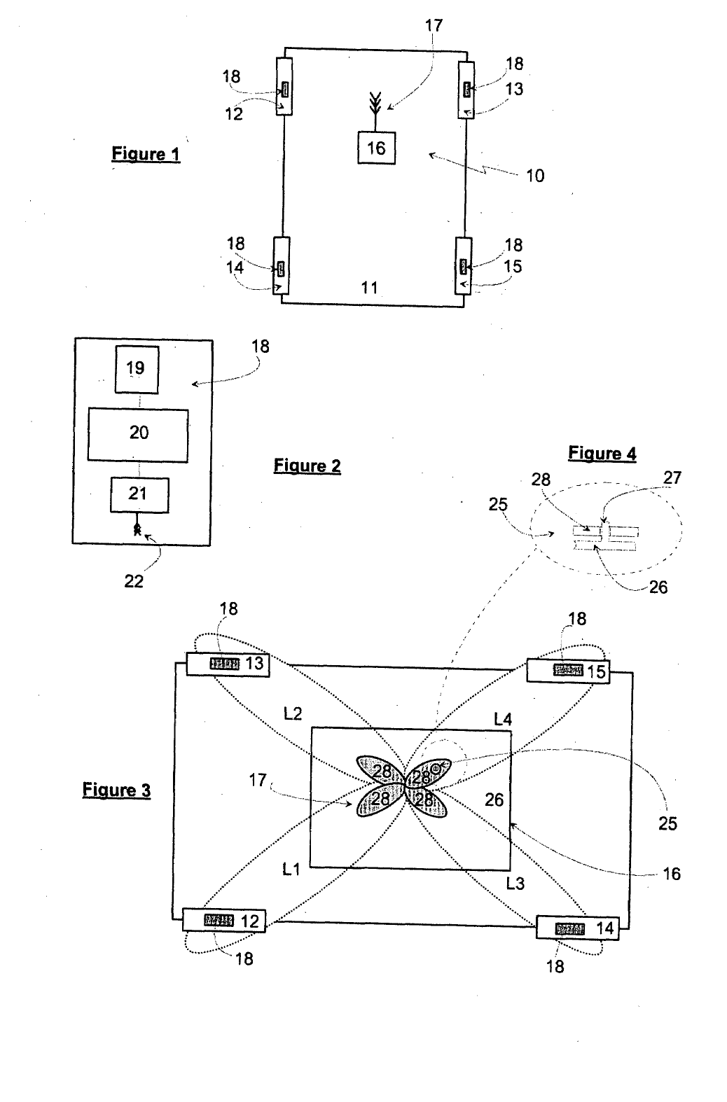

FIG. 1 is a diagrammatic view from above, representing a vehicle provided with a tire pressure monitoring system according to the invention,

FIG. 2 is a diagrammatic view of a wheel unit according to the invention,

FIG. 3 is a diagrammatic view representing a vehicle provided with a central unit comprising an active antenna according to the invention, and

FIG. 4 is a view on a magnified scale of the detail referenced 25 in FIG. 3.

According to the embodiment represented in FIGS. 1 to 4, the tire pressure monitoring system 10 according to the invention is mounted on a vehicle 11, provided with four wheels 12 to 15. In each of the tires of this vehicle, a wheel unit 18 (FIGS. 1 and 2) is installed.

This wheel unit 18 comprises at least one pressure and temperature sensor 19. It could also comprise other types of sensors (for example accelerometers, etc.). The wheel unit also comprises a microprocessor 20, able to process the signals measured by the sensors and to shape them so as to transmit them, via a radio frequency transmitter 21 and an antenna 22, to the vehicle. The message thus transmitted to the vehicle contains at least the measured pressure and temperature values (possibly other parameters), a code identifying the transmitting wheel unit, as well as a certain number of data making it possible to verify the consistency of the message.

The tire pressure monitoring system according to the invention furthermore comprises a central unit 16 (FIG. 1) situated in the vehicle. This central unit is provided with an active antenna 17, termed a multilobed antenna with controlled lobes. This antenna consists, in the example represented (see FIG. 3), of four branches 28, each receiving the radio frequency signals transmitted by any transmitter device situated in an associated lobe (L1 to L4). Each of these lobes covers a well-defined zone of the vehicle. Thus lobe L1 covers the wheel 12 (front left), lobe L2 covers the wheel 13 (front right), lobe L3 covers the wheel 14 (rear right) and lobe L4 covers the wheel 15 (rear right).

Whatever the vehicle, arrangements are made such that the lobes L1 to L4 thus always cover the wheels 12 to 15, whose positioning is known. For this purpose the antenna 17 is provided with foolproofing means 25 (FIGS. 3 and 4) making it possible to place it rigorously in the same position with respect to the vehicle. These foolproofing means 25 (better visible in FIG. 4) can for example be made in the form of a stud 27 made in the support 26 of the antenna (generally a printed circuit) and cooperating with a notch made in one of the branches 28 of the antenna 17. Thus, if the correct branch of the antenna is not installed in front of the stud, the latter cannot cooperate with the notch and it then is impossible to place the active antenna on its printed circuit.

Of course any other foolproofing means can be used.

The method of detecting a transmission fault of a wheel unit according to the invention consists after message transmission by the wheel units in:

receiving these messages at the level of the central unit (16) provided, for this purpose, with an active antenna (17) exhibiting a plurality of reception lobes (L1 to L4) each able to receive the messages originating from a predetermined wheel unit (18),

deactivating a lobe (L1 to L4) when the latter has received a message originating from the wheel unit (18) with which it is associated, and standing by for the next messages transmitted for the lobes that remain active,

repeating the receiving and deactivating steps until all the lobes of the active antenna have received their messages,

reactivating the deactivated reception lobes when a predetermined time span has elapsed or if all the messages of all the wheel units have been received. In the case where all the wheel units have not been received, counting the wheel units not received as “mute” and reactivating all the lobes.

When a wheel unit has not been received for a predetermined number of times, that is to say when it has been counted “mute” a certain number of times, this wheel unit is declared “mute”.

The deactivating of each reception lobe, after receiving a message originating from the associated wheel unit, is carried out by any appropriate means, for example with the aid of a controlled switch.

The method according to the invention is for example implemented in the following manner.

All the reception lobes of the active antenna are activated. Following a message dispatched by the wheel unit 18 of the wheel 13, the lobe L2 receives a message. This message is processed by the central unit 16 and the lobe L2 is deactivated. The messages originating from the wheels 12 and 15 (lobes L1 and L4) collide and the central unit cannot process either of these messages. The message originating from the wheel 12 (lobe L1) is ultimately received. This lobe L1 is deactivated. Only the lobes L3 and L4 remain active. The messages originating from the wheels 12 and 15 can no longer collide. The messages originating from the wheels 14 and 15 are then received without collision (that is to say sequentially) and processed. The whole set of messages having been received, the four lobes are then reactivated. The “mute” wheel counter is not incremented, since the messages originating from all the wheel units have been received.

The mode of implementation given above has of course been indicated only by way of illustration and the sequence for activating and deactivating the reception lobes can be different from that described without thereby departing from the field of the invention. In the case illustrated above no wheel unit has any transmission problem.

The present invention also relates to a detection device implementing an active antenna with controlled reception lobes.

It will be noted that the method and the device according to the invention also make it possible to locate the various wheel units on the vehicle. Specifically, as each reception lobe of the active antenna receives the transmissions originating from a determined wheel, it suffices when a lobe receives a message originating from the wheel unit with which it is associated to store the number identifying the wheel unit. Thus if it is lobe L1 which receives the message comprising the number identifying the wheel unit, it is known that this wheel unit is the one mounted in the wheel 12 (front left). The identifying number received is then stored as being that of the front left wheel. The same is done for each of the other wheel units.

Of course, the present invention is not limited to the embodiment described by way of example. Thus the antenna 17 can exhibit a number of reception lobes other than four. Furthermore the shape of the branches of the antenna is not limited to that represented. Any antenna with active reception lobes can be used.

1-5. (canceled)

6. A method of detecting a transmission fault of a wheel unit belonging to a tire pressure monitoring system, said system comprising:
a plurality of wheel units (18), comprising at least means (19) for measuring the pressure prevailing inside the tire, means (20) for processing the measurements performed and means for shaping (21) and for dispatching (22) a message containing at least the measurements performed and an identifier of the wheel unit, to a central unit (16),
and a central unit (16) placed in the vehicle (11), able to process the messages received from each wheel unit (18),
said detection method comprising the following steps:
a) transmissions of messages by the wheel units (18),
b) reception of these messages by the central unit (16) provided with an active antenna (17) exhibiting a plurality of reception lobes (L1 to L4) each able to receive a message originating from a predetermined wheel unit (18),
said detection method being characterized in that it furthermore comprises the following steps:
c) when a lobe (L1 to L4) has received a message originating from the wheel unit (18) with which it is associated, deactivation of this lobe and standby for the next messages transmitted for the lobes that remain active,
d) repetition of steps b) and c) until all the lobes of the active antenna have received a message,
e) if after a predetermined time span all the messages of all the wheel units have been received, all the lobes are reactivated, in the converse case the wheel units whose messages have not been received are counted “mute” and then the lobes are all reactivated.

7. The detection method as claimed in claim 6, characterized in that to be declared “mute” a wheel unit (18) must have been counted “mute” a predetermined number of times.

8. The detection method as claimed in claim 6, characterized in that the active antenna (17) exhibits at least four reception lobes.

9. The detection method as claimed in claim 7, characterized in that the active antenna (17) exhibits at least four reception lobes.

10. The detection method as claimed in claim 6, characterized in that during step c) the deactivation of the lobe of the active antenna is carried out by a controlled switch.

11. The detection method as claimed in claim 6, characterized in that it furthermore consists in locating each wheel unit (18) by storing in the central unit (16) the identifier of the wheel unit corresponding to each of the reception lobes (L1 to L4) of the active antenna.

12. The detection method as claimed in claim 7, characterized in that during step c) the deactivation of the lobe of the active antenna is carried out by a controlled switch.

13. The detection method as claimed in claim 7, characterized in that it furthermore consists in locating each wheel unit (18) by storing in the central unit (16) the identifier of the wheel unit corresponding to each of the reception lobes (L1 to L4) of the active antenna.

14. The detection method as claimed in claim 8, characterized in that during step c) the deactivation of the lobe of the active antenna is carried out by a controlled switch.

15. The detection method as claimed in claim 8, characterized in that it furthermore consists in locating each wheel unit (18) by storing in the central unit (16) the identifier of the wheel unit corresponding to each of the reception lobes (L1 to L4) of the active antenna.

16. The detection method as claimed in claim 10, characterized in that it furthermore consists in locating each wheel unit (18) by storing in the central unit (16) the identifier of the wheel unit corresponding to each of the reception lobes (L1 to L4) of the active antenna.
